(19) United States
(12) Patent Application Publication
(10) Pub. No.: US 2016/0061617 A1
(43) Pub. Date: Mar. 3, 2016

(54) PROVIDING IN-NAVIGATION SEARCH RESULTS THAT REDUCE ROUTE DISRUPTION

(71) Applicant: Microsoft Corporation, Redmond, WA (US)

(72) Inventors: Finbarr Duggan, Bray (IE); John Murphy, Athlone (IE); Gary Sherman, Dublin (IE)

(73) Assignee: Microsoft Corporation, Redmond, WA (US)

(21) Appl. No.: 14/475,143

(22) Filed: Sep. 2, 2014

(51) Int. Cl. G01C 21/34; G06F 17/30; G01C 21/36

(52) U.S. Cl. CPC G01C 21/3476; G01C 21/3605; G06F 17/30554; G06F 17/3053

(57) ABSTRACT

Systems and methods disclosed herein may include providing search results. A route offset may be determined, where the route offset at least in part defines a search area for a route. A search result may be received from a point-of-interest (POI) search within the search area. The search result may include a set of POIs associated with a POI category. The set of POIs in the search result may be ranked based at least in part on route disruption criteria. The route disruption criteria for a given one of the POIs may measure additional travel if the route is changed to include the given POI. One or more of the ranked set of POIs may be presented. A selection of the POI category and a mode of transportation for the route may be received. The mode of transportation may include one of driving, bicycling, traveling by public transportation, or walking.

### BACKGROUND

As computing technology has advanced, increasingly powerful mobile devices have become available. For example, smartphones and other computing devices have become commonplace. The mobility of such devices has resulted in different types of functionalities being developed, such as navigation-related functionalities.

Computer-aided map navigation tools have achieved widespread acceptance. Using a Web browser, a user can find an address or directions with map navigation tools available at various Web sites. Some software programs allow a user to navigate over a map, zooming in towards the ground or zooming out away from the ground, or moving between different geographical positions. In cars, GPS devices have provided rudimentary road navigation for years. More recently, map navigation software for cellular telephones and other mobile computing devices has allowed users to zoom in, zoom out, and move around a map that shows details about geographical features, town, city, county and state locations, roads, and buildings.

In instances when a user is navigating between two places, such as on a long car journey, it is not uncommon for the user to search for services, such as gas stations or restaurants, using a mobile computing device. Typically, performing the search means the user needs to interrupt the computer-aided map navigation and use the mobile computing device to perform the search. However, many of the results that are returned from such searching are likely to be inappropriate. Searching for points-of-interest (POIs), such as restaurants, shops or gas stations, typically returns results which are located in the vicinity of the user (or, more specifically, the user's mobile computing device). In this regard, for a typical result set, half the results are places the user has already passed along the navigation route, and some of the remaining results will take the user too far off the current route to be useful. Such a conventional approach is limited since it does not permit the user to formulate more complex queries, compare results or see only results that are ahead on the route.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a method for providing search results may include determining a route offset, where the route offset at least in part defines a search area for a route (e.g., along the route, around a point on the route). A search result may be received from a point-of-interest (POI) search within the search area. The search result may include a set of POIs. The set of POIs can include a single POI or multiple POIs. The set of POIs in the search result may be ranked based at least in part on route disruption criteria. The route disruption criteria for a given one of the POIs may measure additional travel (e.g., additional travel time) if the route is changed to include the given POI. The ranking of a POI may also depend, at least in part, on a search ranking provided with the search results and/or proximity of the POI to the current location of the computing device or an access point on the route that is nearest the POI. One or more of the ranked set of POIs may be presented (e.g., displayed, voice-announced). A selection of a POI category for the POI search and a mode of transportation for the route may be received. The mode of transportation may include one of driving (e.g., using a car or a motorcycle), traveling by public transportation, bicycling, or walking.

In accordance with one or more aspects, a method for providing search results may include receiving an input specifying a point-of-interest (POI) category. A search area may be determined along an established route. The search area may include an area around a portion of the established route located between a current location of the computing device and a destination point associated with the established route. In response to receiving a search result that includes a set of POIs located within the search area and associated with the POI category, a route disruption metric associated with additional travel time may be determined for each POI within the set of POIs. The additional travel time may be determined by changing the established route to include the POI. The set of POIs may be ranked based at least in part on the route disruption criteria to generate a ranked POI list. A top-ranked POI from the ranked POI list may be presented.

In accordance with one or more aspects, a method of providing search results may include receiving an input specifying a destination point. A travel route may be selected from a current location of the computing device to the destination point, the selecting based on a mode of transportation (e.g., in user settings). A route offset may be determined, where the route offset at least in part defines a search area. The search area may be located along part of the route, if the mode of transportation is driving, bicycling, or walking. The search area may also be located around a public transportation stop on the route (e.g., at the destination point, at an intermediate stop), if the mode of transportation is public transport. A search result from a POI search within the search area may be received. The search result may include a set of POIs associated with a POI category. The set of POIs in the search result may be ranked based at least in part on route disruption criteria. The route disruption criteria for a given one of the POIs may measure additional travel, if the route is changed to include the given POI. One or more of the ranked set of POIs may be presented.

The various innovations described herein can be implemented as part of a method, as part of a computing system adapted to perform the method or as part of tangible computer-readable media having computer-executable instructions for causing a computing system to perform the method. The various innovations can be used in combination or separately. As described herein, a variety of other features and advantages can be incorporated into the technologies as desired.

### BRIEF DESCRIPTION OF THE DRAWINGS

FIG. 1 is a block diagram illustrating an example mobile computing device in conjunction with which innovations described herein may be implemented.

FIG. 2 is a block diagram illustrating an example software architecture for a map navigation tool, which may be used to provide in-navigation search results that reduce route disruption, in accordance with one or more example embodiments of the disclosure.

FIG. 3 is a diagram of search areas, which may be used in connection with providing in-navigation search results that reduce route disruption, in accordance with one or more example embodiments of the disclosure.

FIGS. 4-5 are diagrams of travel routes and example search areas with POI search results that reduce route disruption, in accordance with one or more example embodiments of the disclosure.

FIGS. 6-8 are flow diagrams illustrating providing of in-navigation search results, in accordance with one or more example embodiments of the disclosure.

FIG. 9 is a diagram of an example computing system, in which one or more example embodiments of the disclosure can be implemented.

### DETAILED DESCRIPTION

As described herein, various techniques and solutions can be applied so that in-navigation search results may be provided that reduce route disruption. A search area along a travel route may be constructed based on an offset value. For example, the offset may be a fixed distance (e.g., 250 yards) that can be applied on both sides of part of the route (e.g., the remaining part of the route, the next x miles of the route) to obtain the search area (i.e., the search area will run along the part of route and will be 500 yards wide). Other search area configurations may be used as well, as discussed herein.

A user may use a computing device to initially enter a destination point, a mode of transportation, and a point-of-interest (POI) category. These inputs can be entered at different times (e.g., in user settings, for input of the mode of transportation; when requesting directions, for input of the destination point; and when requesting a search during navigation, for input of the POI category). Or, optionally, the mode of transportation (e.g., walking, driving, bicycling, or public transport) may be detected by the speed the user and the computing device are moving. The POI category may alternatively be obtained from a personal profile (e.g., from one or more preferences associated with previous travel, or stated in an email, calendar appointment, note, and so forth). A POI search may be performed within the search area for POIs that are associated with the POI category. Elements (POIs) of the result set will be individually tested to determine the effect of adding each to the route underway. The difference between the route estimate with and without a POI added is a disruption metric associated with that POI. The POIs may then be ranked based on the disruption metrics (and potentially on other factors such as search ranking and/or proximity), and the complete list (or a top-ranked POI or a partial list) may be presented at the computing device (e.g., displayed or voice-announced). A selected POI may be added to the route, and the route may be adjusted accordingly.

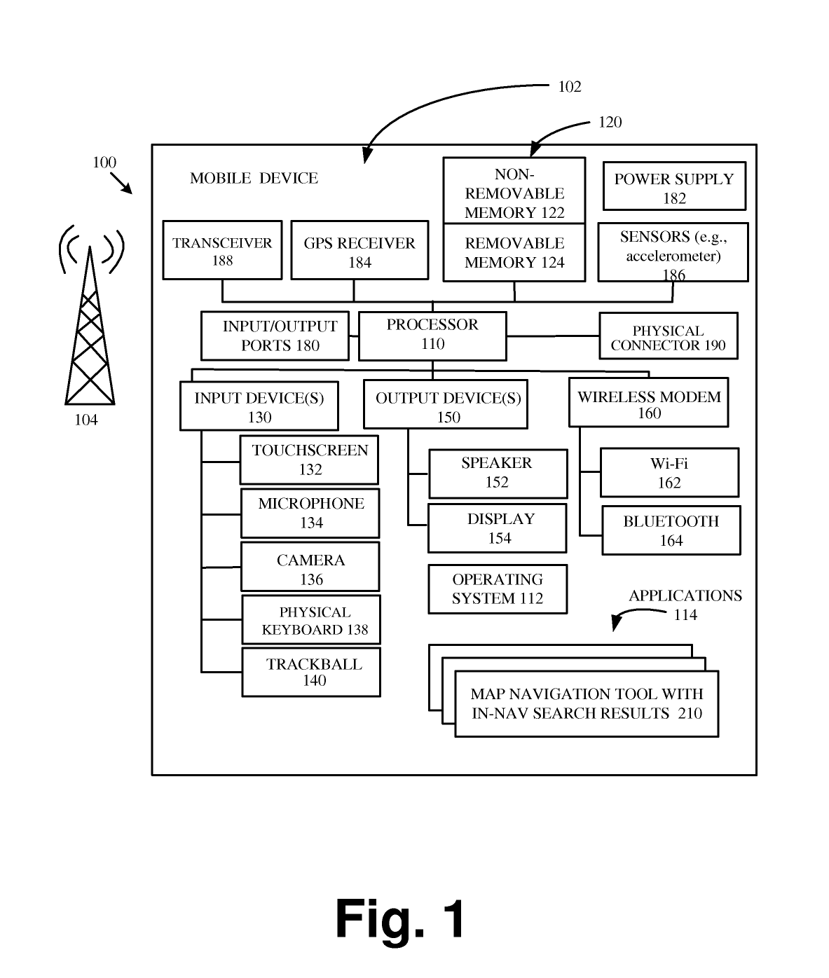

FIG. 1 is a block diagram illustrating an example mobile computing device (100) in conjunction with which innovations described herein may be implemented. The mobile device (100) includes a variety of optional hardware and software components, shown generally at (102). In general, a component (102) in the mobile device can communicate with any other component of the device, although not all connections are shown, for ease of illustration. The mobile device 100 can be any of a variety of computing devices (e.g., cell phone, smartphone, handheld computer, laptop computer, notebook computer, tablet device, netbook, media player, Personal Digital Assistant (PDA), camera, video camera, etc.) and can allow wireless two-way communications with one or more mobile communications networks (104), such as a Wi-Fi, cellular, or satellite network.

The illustrated mobile device (100) includes a controller or processor (110) (e.g., signal processor, microprocessor, ASIC, or other control and processing logic circuitry) for performing such tasks as signal coding, data processing (including assigning weights and ranking data such as search results), input/output processing, power control, and/or other functions. An operating system (112) controls the allocation and usage of the components (102) and support for one or more application programs (114), such as a map navigation tool (210) that implements one or more of the innovative features described herein. The map navigation tool (210) can be a mapping application, or it can be part of a software-based personal assistant or some other software tool. In addition to map navigation software, the application programs 114 can include common mobile computing applications (e.g., telephony applications, email applications, calendars, contact managers, web browsers, messaging applications), or any other computing application.

The illustrated mobile device (100) includes memory (120). Memory (120) can include non-removable memory (122) and/or removable memory (124). The non-removable memory (122) can include RAM, ROM, flash memory, a hard disk, or other well-known memory storage technologies. The removable memory (124) can include flash memory or a Subscriber Identity Module (SIM) card, which is well known in Global System for Mobile Communications (GSM) communication systems, or other well-known memory storage technologies, such as “smart cards.” The memory (120) can be used for storing data and/or code for running the operating system (112) and the applications (114). Example data can include web pages, text, images, sound files, video data, or other data sets to be sent to and/or received from one or more network servers or other devices via one or more wired or wireless networks. The memory (120) can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device (100) can support one or more input devices (130), such as a touch screen (132) (e.g., capable of capturing finger tap inputs, finger gesture inputs, or keystroke inputs for a virtual keyboard or keypad), microphone (134) (e.g., capable of capturing voice input), camera (136) (e.g., capable of capturing still pictures and/or video images), physical keyboard (138), buttons and/or trackball (140) and one or more output devices (150), such as a speaker (152) and a display (154). Other possible output devices (not shown) can include piezoelectric or other haptic output devices. Some devices can serve more than one input/output function. For example, touchscreen (132) and display (154) can be combined in a single input/output device.

The mobile device (100) can provide one or more natural user interfaces (NUIs). For example, the operating system (112) or applications (114) can comprise speech-recognition software as part of a voice user interface that allows a user to operate the device (100) via voice commands. For example, a user's voice commands can be used to provide input to a map navigation tool.

A wireless modem (160) can be coupled to one or more antennas (not shown) and can support two-way communications between the processor (110) and external devices, as is well understood in the art. The modem (160) is shown generically and can include, for example, a cellular modem for communicating at long range with the mobile communication network (104), a Bluetooth-compatible modem (164), or a Wi-Fi-compatible modem (162) for communicating at short range with an external Bluetooth-equipped device or a local wireless data network or router. The wireless modem (160) is typically configured for communication with one or more cellular networks, such as a GSM network for data and voice communications within a single cellular network, between cellular networks, or between the mobile device and a public switched telephone network (PSTN).

The mobile device can further include at least one input/output port (180), a power supply (182), a satellite navigation system receiver (184), such as a Global Positioning System (GPS) receiver, sensors (186) such as an accelerometer, a gyroscope, or an infrared proximity sensor for detecting the orientation and motion of device (100), and for receiving gesture commands as input, a transceiver (188) (for wirelessly transmitting analog or digital signals), and/or a physical connector (190), which can be a USB port, IEEE 1394 (FireWire) port, and/or RS-232 port. The illustrated components (102) are not required or all-inclusive, as any of the components shown can be deleted and other components can be added.

The mobile device can determine location data that indicates the location of the mobile device based upon information received through the satellite navigation system receiver (184) (e.g., GPS receiver). Alternatively, the mobile device can determine location data that indicates location of the mobile device in another way. For example, the location of the mobile device can be determined by triangulation between cell towers of a cellular network. Or, the location of the mobile device can be determined based upon the known locations of Wi-Fi routers in the vicinity of the mobile device. The location data can be updated every second or on some other basis, depending on implementation and/or user settings. Regardless of the source of location data, the mobile device can provide the location data to map navigation tool for use in map navigation. For example, the map navigation tool (210) periodically requests, or polls for, current location data through an interface exposed by the operating system (112) (which in turn may get updated location data from another component of the mobile device), or the operating system (112) pushes updated location data through a callback mechanism to any application (such as the map navigation tool 210) that has registered for such updates.

With the map navigation tool (210) and/or other software or hardware components, the mobile device (100) implements the technologies described herein. For example, the processor (110) can process input regarding a navigation route (e.g., between a starting point, or a detected current location, and a destination point), detect mode of transportation (e.g., based on detected speed/acceleration, or based on a user setting), establish an offset (e.g., based on the mode of transportation and/or a user setting) for purposes of determining a search area, process POI category information (e.g., obtaining a POI category preference based on a user profile, user email messages, calendar schedule, notes, and so forth), determine disruption measures by applying disruption criteria for one or more POIs (e.g., extra time it will take to travel to and back from a POI if the POI is included in a current travel route), process POI search results by assigning weights (e.g., based on the disruption measures, search rankings and/or route proximity) to each POI in the search result, present a ranked POI list at the computing device, include a selected POI to a current route and modify route directions accordingly, and so forth.

As a client computing device, the mobile device (100) can send requests to a server computing device (e.g., a search server, a routing server, and so forth), and receive map images, distances, directions, other map data, search results (e.g., POIs based on a POI search within a designated search area), or other data in return from the server computing device.

The mobile device (100) can be part of an implementation environment in which various types of services (e.g., computing services) are provided by a computing “cloud.” For example, the cloud can comprise a collection of computing devices, which may be located centrally or distributed, that provide cloud-based services to various types of users and devices connected via a network such as the Internet. Some tasks (e.g., processing user input and presenting a user interface) can be performed on local computing devices (e.g., connected devices) while other tasks (e.g., storage of data to be used in subsequent processing, determination of routes, performance of searches, weighting of search results, ranking of search results according to general search criteria or user preferences) can be performed in the cloud.

Although FIG. 1 illustrates a mobile device (100), more generally, the innovations described herein can be implemented with devices having other screen capabilities and device form factors, such as a desktop computer, a television screen, or device connected to a television (e.g., a set-top box or gaming console). Services can be provided by the cloud through service providers or through other providers of online services. Thus, the map navigation innovations described herein can be implemented with any of the connected devices as a client computing device. Similarly, any of various computing devices in the cloud or a service provider can perform the role of server computing device and deliver map data or other data to the connected devices.

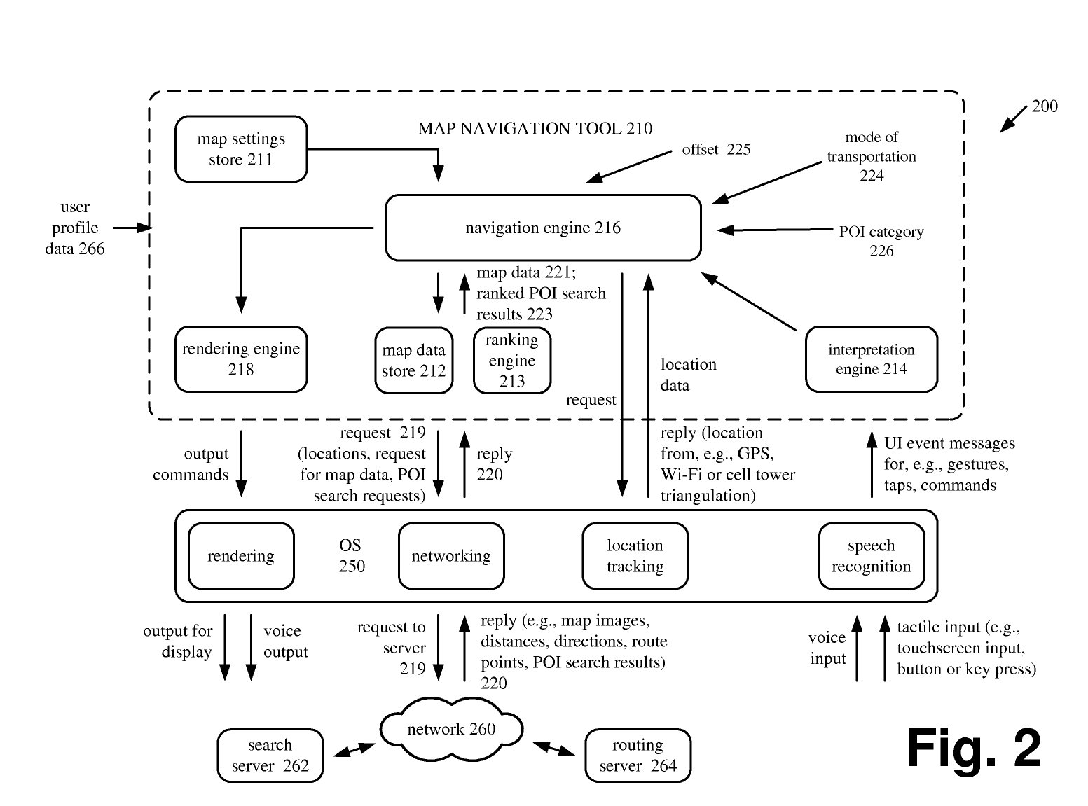

FIG. 2 is a block diagram illustrating an example software architecture (200) for a map navigation tool (210), which may be used to provide in-navigation search results that reduce route disruption, in accordance with one or more example embodiments of the disclosure. A client computing device (e.g., smartphone or other mobile computing device such as device (100)) can execute software for a map navigation tool (210) and OS (250) organized according to the architecture (200) to provide in-navigation search results that reduce route disruption.

The architecture (200) includes a device operating system (OS) (250) and map navigation tool (210). In FIG. 2, the device OS (250) includes components for rendering (e.g., rendering visual output to a display, generating voice output for a speaker), components for networking, components for location tracking, and components for speech recognition and other input processing. The device OS (250) manages user input functions, output functions, storage access functions, network communication functions, and other functions for the device (100). The device OS (250) provides access to such functions to the map navigation tool (210).

A user can generate user input that affects map navigation. The user input can be tactile input such as touchscreen input, button presses or key presses or voice input. The device OS (250) includes functionality for recognizing taps, finger gestures, etc. to a touchscreen from tactile input, recognizing commands from voice input, button input or key press input, and creating messages that can be used by map navigation tool (210) or other software. The interpretation engine (214) of the map navigation tool (210) listens for user input event messages from the device OS (250). The UI event messages can indicate a panning gesture, flicking gesture, dragging gesture, or other gesture on a touchscreen of the device, a tap on the touchscreen, keystroke input, or other UI event (e.g., from voice input, directional buttons, trackball input). If appropriate, the interpretation engine (214) can translate the UI event messages from the OS (250) into map navigation messages sent to a navigation engine (216) of the map navigation tool (210).

The navigation engine (216) considers a current view position (possibly provided as a saved or last view position from the map settings store (211)), any messages from the interpretation engine (214) that indicate a desired change in view position, map data and location data. From this information, the navigation engine (216) determines a view position and provides the view position as well as location data and map data in the vicinity of the view position to the rendering engine (218). The location data can indicate a current location (of the computing device with the map navigation tool (210)) that aligns with the view position, or the view position can be offset from the current location.

The navigation engine (216) gets current location data for the computing device from the operating system (250), which gets the current location data from a local component of the computing device. For example, the location data can be determined based upon data from a global positioning system (GPS), by triangulation between towers of a cellular network, by reference to physical locations of Wi-Fi routers in the vicinity, or by another mechanism.

The navigation engine (216) gets map data (221) for a map from a map data store (212). In general, the map data can be photographic image data or graphical data (for boundaries, roads, etc.) at various levels of detail, ranging from high-level depiction of states and cites, to medium-level depiction of neighborhoods and highways, to low-level depiction of streets and buildings. Aside from photographic data and graphical data, the map data (221) can include graphical indicators such as icons or text labels for place names of states, cities, neighborhoods, streets, buildings, landmarks or other features in the map. Aside from names, the map data can include distances between features, route points (in terms of latitude and longitude) that define a route between start and destination points, text directions for decisions at waypoints along the route (e.g., turn at NE 148th), and distances between waypoints along the route. The map data can provide additional details for a given feature such as contact information (e.g., phone number, Web page, address), reviews, ratings, other commentary, menus, photos, advertising promotions, or information for games (e.g., geo-caching, geo-tagging). Links can be provided for Web pages, to launch a Web browser and navigate to information about the feature.

The organization of the map data (221) depends on implementation. For example, in some implementations, different types of map data (photographic image data or graphical surface layer data, text labels, icons, etc.) are combined into a single layer of map data at a given level of detail. Up to a certain point, if the user zooms in (or zooms out), a tile of the map data at the given level of detail is simply stretched (or shrunk). If the user further zooms in (or zooms out), the tile of map data at the given level of detail is replaced with one or more other tiles at a higher (or lower) level of detail. In other implementations, different types of map data are organized in different overlays that are composited during rendering, but zooming in and out are generally handled in the same way, with overlapping layers stretched (or shrunk) to some degree, and then replaced with tiles at other layers.

The map data store (212) caches recently used map data. As needed, the map data store (212) gets additional or updated map data from local file storage or from network resources. The device OS (250) mediates access to the storage and network resources. The map data store (212) requests map data from storage or a network resource through the device OS (250), which processes the request, as necessary requests map data from a server and receives a reply, and provides the requested map data to the map data store (212).

For example, to determine directions for a route, the map navigation tool (210) provides a start point (typically, the current location of the computing device with the map navigation tool (210)) and a destination point for a destination (e.g., an address or other specific location) as part of a request for map data to the OS (250). The device OS (250) conveys the request over a network (260) to one or more servers (e.g., routing server 264), which provide surface layer data, route points that define a route, text directions for decisions at waypoints along the route, distances between waypoints along the route, and/or other map data in reply. The device OS (250) in turn conveys the reply (220), which includes the map data (221) to the map navigation tool (210). The map data (221) may be optionally stored within the map data store (212) and/or communicated directly to the navigation engine (216).

As another example, as a user travels along a route, the map navigation tool (210) gets additional map data from the map data store (212) for rendering. The map data store (212) may cache detailed map data for the vicinity of the current location, using such cached data to incrementally change the rendered views. The map navigation tool (210) can pre-fetch map data along the route, or part of the route. Thus, as the rendered map views are updated to account for changes to the current location, the map navigation tool (210) often updates the display without the delay of requesting/receiving new map data from a server. As needed, the map data store (212) requests additional map data to render views.

The rendering engine (218) processes the view position, location data and map data, and renders a view of the map. Depending on the use scenario, the rendering engine (218) can render map data from local storage, map data from a network server, or a combination of map data from local storage and map data from a network server. In general, the rendering engine (218) provides output commands for the rendered view to the device OS (250) for output on a display. The rendering engine (218) can also provide output commands to the device OS (250) for voice output over a speaker or headphones.

The exact operations performed as part of the rendering depend on implementation. In some implementations, for map rendering, the tool determines a field of view and identifies features of the map that are in the field of view. Then, for those features, the tool selects map data elements. This may include any and all of the map data elements for the identified features that are potentially visible in the field of view. Or, it may include a subset of those potentially visible map data elements which are relevant to the navigation scenario (e.g., directions, traffic). For a given route, the rendering engine (218) graphically connects route points along the route (e.g., with a highlighted color) to show the route and graphically indicates waypoints along the route. The tool composites the selected map data elements that are visible (e.g., not obscured by another feature or label) from the view position. Alternatively, the tool implements the rendering using acts in a different order, using additional acts, or using different acts.

In terms of overall behavior, the map navigation tool can react to changes in the location of the computing device and can also react to user input that indicates a change in view position, a change in the top item in a list of directions for a route, or other change. For example, in response to a finger gesture or button input that indicates a panning instruction on the map, or upon a change to a previous item or next item in a list of directions for a route, the map navigation tool can update the map with a simple, smooth animation that translates (shifts vertically and/or horizontally) the map. Similarly, as the location of the computing device changes, the map navigation tool can automatically update the map with a simple translation animation. (Or, the map navigation tool can automatically re-position and re-render an icon that indicates the location of the computing device as the location is updated.) If the change in location or view position is too large to be rendered effectively using a simple, smooth translation animation, the map navigation tool can dynamically zoom out from at first geographic position, shift vertically and/or horizontally to a second geographic position, then zoom in at the second geographic position. Such a dynamic zoom operation can happen, for example, when a phone is powered off then powered on at a new location, when the view position is re-centered to the current location of the device from far away, when the user quickly scrolls through items in a list of directions for a route, or when the user scrolls to a previous item or next item in the list of directions that is associated with a waypoint far from the current view position. The map navigation tool can also react to a change in the type of view (e.g., to switch from a map view to a list view, or vice versa) or a change in details to be rendered (e.g., to show or hide traffic details).

In accordance with an example embodiment of the disclosure, the map navigation tool (210) may be used to provide in-navigation search results that reduce route disruption. For example and as explained above, the map navigation tool (210) may be used to establish a travel route between a starting point (e.g., a current location of the device (100)) and a destination point. The request (219) may include information on the starting and destination points and may be communicated over the network (260) to the routing server (264). The reply (220) from the routing server (264) may include the travel route data (e.g., as part of map data (221)), which may be rendered by the OS (250) (e.g., continuously, as the user of device (100) travels along the established route).

In some instances, a mode of transportation (224) (e.g., walking, bicycling, driving, public transport) may be entered (e.g., by a user or determined from user settings or application settings) and used by the navigation engine (216) in providing in-navigation search results, as described herein. The mode of transportation (224) may also be automatically detected based on, for example, speed or acceleration of the moving device (100).

In an example embodiment, the map navigation tool (210) may automatically determine an offset value (225) based on, e.g., the mode of transportation (224) and/or application settings. The offset (225) and the travel route information (e.g., as received from the routing server (264)) may be used by the map navigation tool (210) to determine a search area and specify a POI search within the search area. In this regard, the map navigation tool (210) may obtain POI category (226) (e.g., from user input using the device (100), or by accessing user profile data (266) and extracting POI category information from one or more of email data, calendar data, notes, and so forth). The POI category (226) may include a specific business (e.g., restaurant, gas station), category of business, specific landmark (e.g., park), category of landmarks, and/or any other type of POI.

After the search area has been determined (e.g., based on the offset (225) and the established travel route), the search area and the POI category (226) may be communicated to the search server (262) via a request (219) communicated through the ranking engine (213) or another component. The reply (220) may include one or more POIs within the search area, which belong to the POI category (226). The reply (220) with the POI search results may be communicated to the ranking engine (213). The ranking engine (213) may comprise suitable logic, circuitry, interfaces, and/or code and may be operable to rank the POI search results based on, for example, any one or more of route disruption criteria (“RDC”) (e.g., route disruption time), search rank information (e.g., provided with search results, or based on user profile or preferences noted in a software-based digital assistant), proximity to the main travel route (e.g., current location on the route, or access point on the route nearest to a POI), and so forth. The ranking engine (213) may determine a route disruption metric for a POI by, for example, determining extra time used if the current travel route includes the specific POI (e.g., extra time needed to travel to the POI and back to the current travel route, or extra time associated with a new route including the POI and the destination point, in comparison to the current route that does not include the POI). In some instances, the ranking engine (213) may communicate location information for each POI in the search results (as received from the search server (262)) to the routing server (264) and receive back a new route that includes the POI, or a determination of the extra time and/or distance that has to be traveled to and from the POI if the current route is used. The ranking engine (213) may apply the RDC to calculate the disruption metric for each POI, and then rank the POIs based on the disruption criteria. Additional ranking criteria such as search ranking (received from the search server (262) together with the POI search results), distance from each POI to the current route (can be provided by the routing server (264) or calculated by the ranking engine (213)), or other criteria. By considering differences in travel time (rather than just distance), the ranking of POIs can account for direction of traffic (e.g., one-way streets), access options (e.g., off-ramps, on-ramps), traffic conditions, construction delays, and other factors that do not necessarily depend on distance.

The ranked POI search results (223) (e.g., the entire ranked POI list, a partial list, or a top-ranked POI) may be communicated to the navigation engine (216) and to the rendering engine (218) for rendering at the device (100) (e.g., rendered on the display or via voice prompts). The number of ranked POI search results (223) presented can depend on form factor (e.g., screen size) of the device.

Alternatively, the POI search results (220) can be directly communicated from the search server (262) to the routing server (264) via the network (260), without the ranking engine (213) of the device (100) acting as an intermediary. In this case, for each of the POIs in the search results, the routing server (264) may return to the ranking engine (213) the information indicating a new route that includes the POI, or a determination of the extra time and/or distance that has to be traveled to and from the POI if the current route is used, which the ranking engine (213) uses to rank POIs.

Also, instead of being located at the device (100) as shown in FIG. 2, the ranking engine (213) can be part of the routing server (264) or another server on the network (260). In this case, the ranking engine (213) can apply ranking criteria (such as RDC, search rankings and/or proximity) to a set of POIs (provided by the search server (262) or map navigation tool (213)), rank the POIs, and return ranked POI search results (223) to the map navigation tool (210).

Alternatively, the map navigation tool (210) includes more or fewer modules. A given module can be split into multiple modules, or different modules can be combined into a single module. For example, the navigation engine can be split into multiple modules that control different aspects of navigation, or the navigation engine can be combined with the interpretation engine and/or the rendering engine. Functionality described with reference to one module (e.g., rendering functionality) can in some cases be implemented as part of another module.

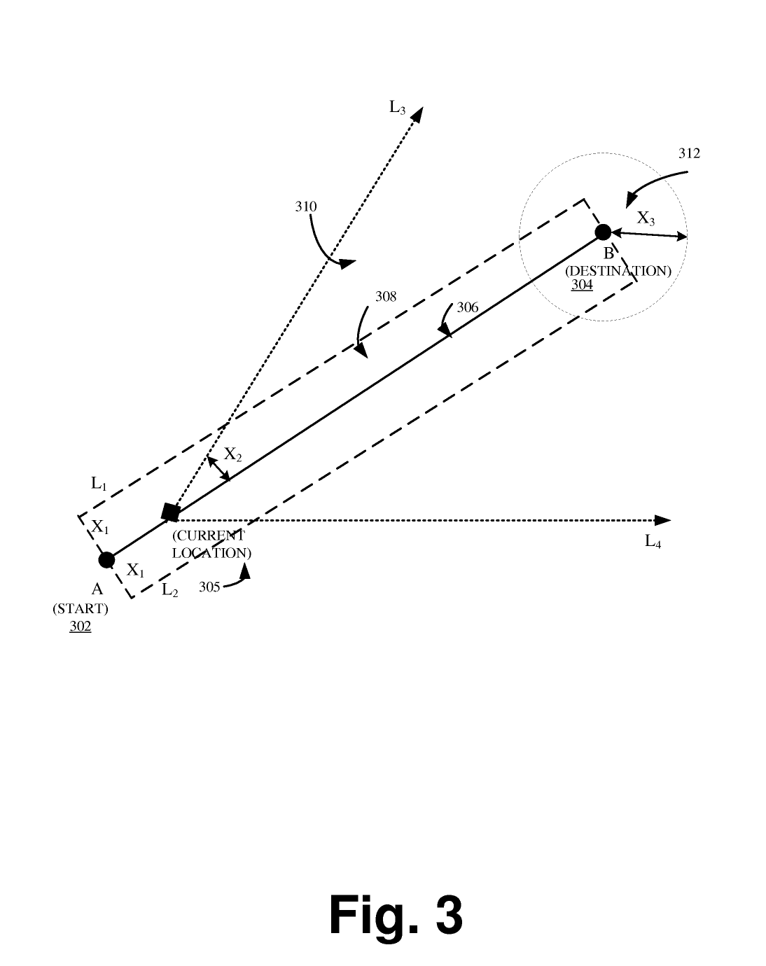

FIG. 3 is a diagram of example search areas, which may be used in connection with providing in-navigation search results that reduce route disruption, in accordance with one or more example embodiments of the disclosure. In general, the search area for POIs includes the area around some portion of a route located between a current location of the computing device and a destination point of the route. Referring to FIG. 3, there are illustrated various types of search areas determined based on a travel route and an offset. A travel route (306) may be determined between a starting point (A) (302) and a destination point (B) (304). In a first example embodiment, an offset X1 may be selected (e.g., by the map navigation tool (210)) and may be applied on both sides of the route (306). More specifically, boundaries L1 and L2 may be determined on both sides of route (306), so that L1 and L2 are each located at a distance X1 from route (306). The resulting search area (308) (disposed between the starting point (302), the destination point (304) and boundaries L1-L2) may be determined and used for POI search. Even though the search area (308) is reflected to start with the starting location (302), the disclosure is not limiting in this regard. In many instances (e.g., when the current location (305) is not close to the start point (302)), one boundary of the search area may pass through or close to (e.g., within a threshold distance such as 100 yards, 200 yards) the current location (305) of device (100) (instead of passing through the starting point (302)). In this case, for additional searches, the search area (308) will be constantly changing as the current location (305) of device (100) changes. Also, the search area (308) can reach the destination point (304), or it can stop after a threshold distance such as 1 mile, 2 miles, or 10 miles from the current location (305). The threshold distance can depend on an application setting, another setting, mode of transportation, speed of travel and/or a selection of a range of search area by the user. Thus, the search area (308) may be range-limited along the route (306) ahead of the current location (305), rather than extending to the destination point (304).

In other embodiments, the offset (225) may include an angle (e.g., X2), and the search area (310) may be a pie-shaped area between boundaries L3-L4, starting with the current location (305). In these embodiments, the search area (310) may be range-limited along the route (306) ahead of the current location (305), rather than extending to the destination point (304). In yet other embodiments, the offset (225) may be a radius X3, defining a circle as the search area (312) (e.g., disposed around the destination point (304) as shown in FIG. 3, or disposed around an intermediate point on the route (306)). This implementation may be suitable if the mode of transportation (224) is public transport and the destination point (304) is the last stop along the public transport route, or the intermediate point is an intermediate stop along the route, from which the user can disembark then re-embark on the route (306).

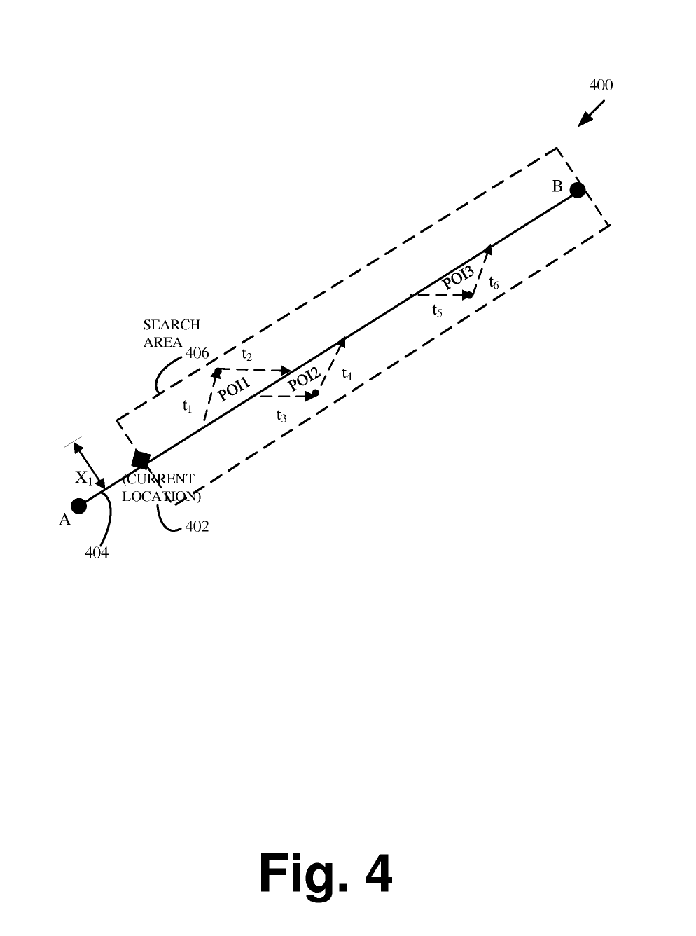

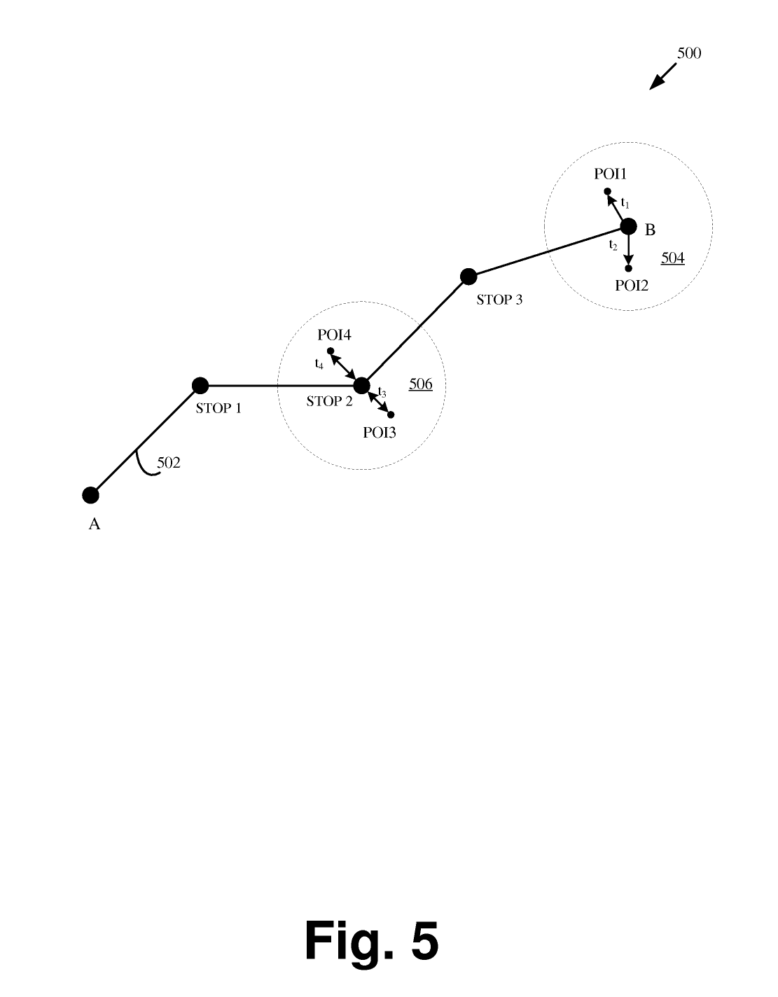

FIGS. 4-5 are diagrams of example travel routes and example search areas with point-of-interest (POI) search results that reduce route disruption, in accordance with one or more example embodiments of the disclosure. Referring to FIG. 4, the diagram (400) illustrates a planned travel route (404) between starting point A and destination point B. There is also illustrated a dynamically adjusting search area (406), with one of its sides passing through or close to the current location (402) of device (100). The search area (406) is defined by some part of the route (404) and offset X1. After the search area (406) (e.g., travel route and offset information) and a POI category (226) are communicated to the search server (262), the POI search result (220) (which includes POIs POI1-POI3 in the example of FIG. 4) may be communicated back to the map navigation tool (210). The ranking engine (213) may communicate the POI1-POI3 location information to the routing server (264) and obtain back distances (and/or additional travel times t1-t6) associated with traveling to and back from each POI. The ranking engine (213) may calculate a route disruption measure based on each of the travel times to the POIs (e.g., times t1, t3, and t5) and travel times from the POIs back to the route (404) (e.g., times t2, t4, and t6). A ranked list of the POIS POI1-POI3 may be communicated to the navigation engine (216) and the rendering engine (218) for rendering at the device (100), thereby providing in-navigation search results that reduce route disruption.

Referring to FIG. 5, there is illustrated a diagram (500) of a planned travel route (502) between a starting point A and a destination point B when the mode of transportation (224) is public transport (e.g., bus). In diagram (500), the route (502) includes bus stops 1, 2, and 3 between the starting point A and the destination point B. In this instance, a search area is represented by a circle around the destination point B. The POI search may return POIs POI1-POI2, which POIs may be ranked according to travel time (e.g., average walking times t1, t2) to POI1 and P012. Since point B is the destination, the walking times may include time of walking to the POI (and not back from the POI to the bus stop at B).

If the POI search does not return any POIs that are associated with the POI category (226), then a new search area (e.g., a circle) may be determined around one or more of the remaining bus stops (e.g., search area around stop 2). Similarly, the POI search within this area may return POIs P013-P014 with average walking times of t3 and t4. Since stop 2 is in intermediate stop, the walking times may include time of walking to the POI and back from the POI to the bus stop 2. In this instance, the ranking of P013 and P014 may take into account the times t3 and t4, respectively, as well as the scheduled time the next bus will be available at stop 2, so that the top-ranked POI will allow for the user of device (100) to visit the POI and still catch the next bus. Alternatively, POIs around multiple stops can be presented.

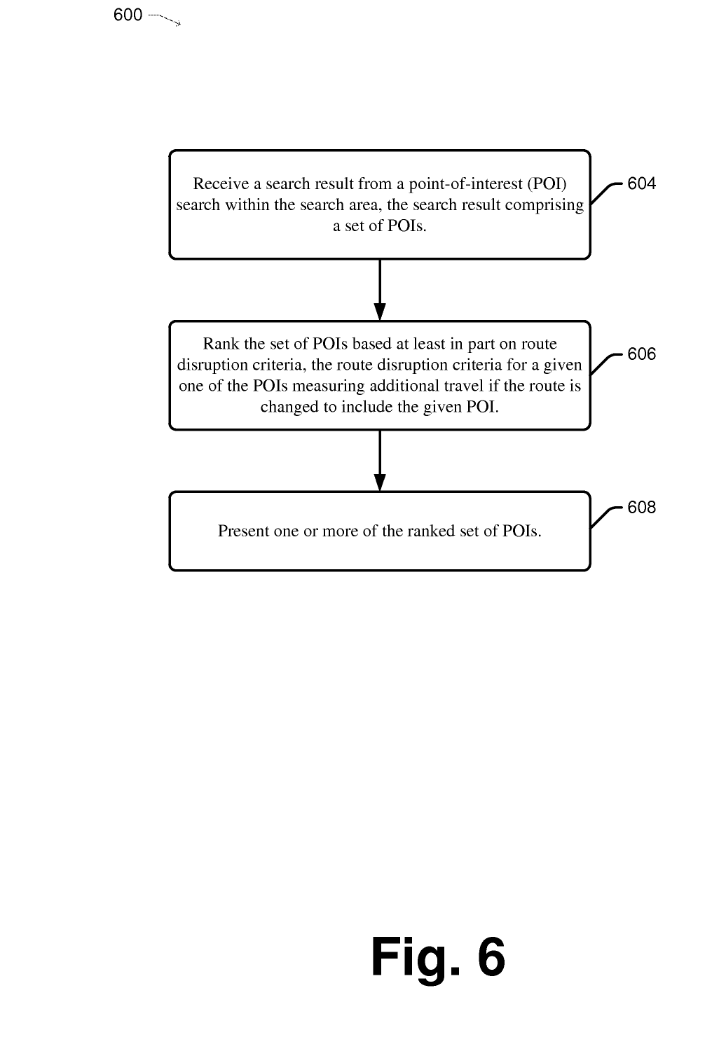

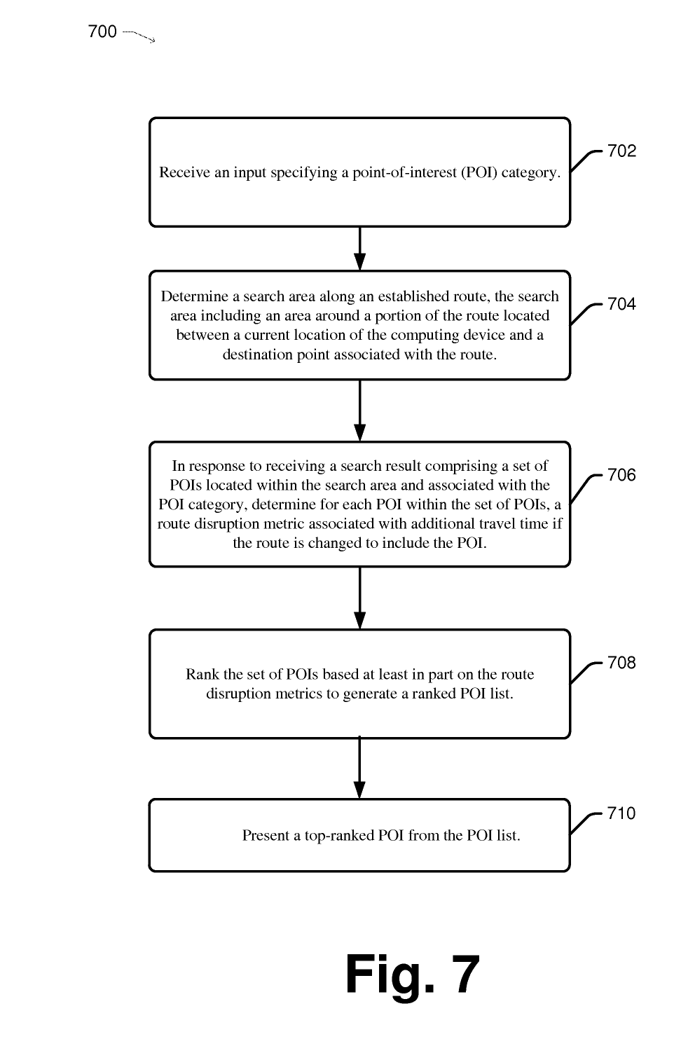

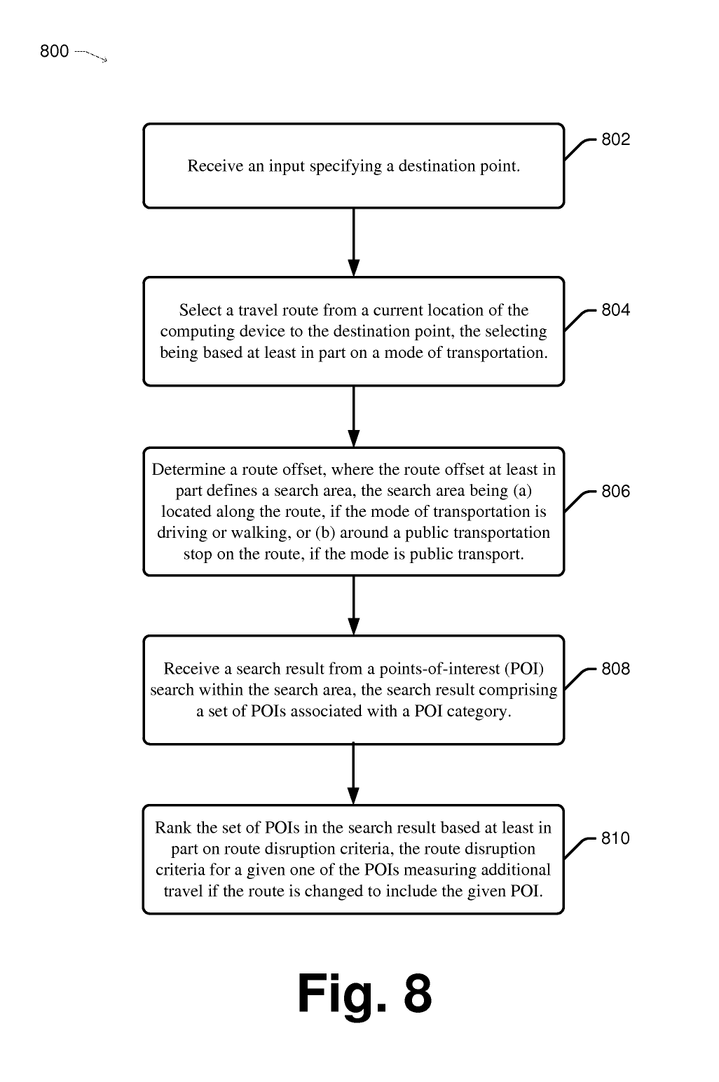

FIGS. 6-8 are flow diagrams illustrating providing of in-navigation search results, in accordance with one or more embodiments of the disclosure. Referring to FIGS. 1-6, the example method (600) may be performed by a map navigation tool (210) at a mobile computing device such as the device (100) of FIG. 1, or it may be performed at a network server such as the routing server (264) of FIG. 2.

Initially (not shown in FIG. 6), a route offset may be determined, where the route offset at least in part defines a search area for a route. For example, the map navigation tool (210) may determine offset (225), such as X1, which may at least in part define a search area. The offset (225) may depend on mode of transportation, which may be specified by the user. The search area may also depend on a portion of the route from a current location of the device (100) to the destination point of the route, as described with reference to FIG. 3.

At (604), a search result (e.g., (220) received from search server (262) may be received from a POI search within the search area. The search result may include a set of POIs (e.g., a single POI or multiple POIs). For example, the POIs fit a POI category (226) selected by a user for the search, which can be provided through user input or obtained based on user profile data 266.

At (606), the set of POIs in the search result may be ranked (e.g., by the ranking engine (213) of the map navigation tool (210), or by a ranking engine at the routing server (264)) based at least in part on route disruption criteria. The route disruption criteria for a given one of the POIs may measure additional travel (e.g., based on extra travel times) if the route is changed to include the given POI (e.g., as a new route, or as a side-trip to the given POI from an access point on the current route and then back to the access point on the current route). The ranking may also account for search ranking (e.g., provided as part of the search results, according to user settings, or according to preferences recorded for the user) and/or proximity of the respective POIs to the current route. The proximity of a POI can be proximity of the POI to a current location of the device (100) or proximity of the POI to an access point on the route that is nearest to the POI.

At (608), one or more of the ranked set of POIs may be presented. For example, at the device (100) with the map navigation tool (210), one or more ranked POIs are displayed (e.g., at a display (154)) or rendered as voice output. Or, when the routing server (264) performs the ranking (606), one or more ranked POIs are provided by the routing server (264) to the map navigation tool (210).

A user can then select one of the ranked set of POIs. For example, a selection of a POI from the ranked set of POIs may be received. In this case, the route may be adjusted to include the selected POI. Alternatively, a POI may be automatically selected and added to a route, e.g., based on a pattern of user behavior or event on a calendar.

Referring to FIGS. 1-5 and 7, the example method (700) may be performed by a map navigation tool (210) at a mobile computing device such as the device (100) of FIG. 1.

The example method (700) may start at (702), when an input specifying a POI category (226) may be received. For example, the input specifying the POI category (226) may be received as user input. Or, the input specifying the POI category (226) may be determined by accessing a user profile (266) and obtaining the input specifying the POI category from an email archive, an online calendar, or other file or document associated with the user profile.

At (704), a search area may be determined along an established route. The search area may include an area around a portion of the established route located between a current location of the computing device and a destination point (B) associated with the route. For example, the portion of the route starts at the current location (or close to the current location) and extends a threshold distance (e.g., 1 mile, 2 miles, 5 miles, 10 miles) along the established route, as described with reference to FIG. 3. A user can provide input that specifies the search area (e.g., a range ahead of the current location). The search area can also be based at least in part on a route offset, as described above.

At (706), in response to receiving a search result (e.g., POI search results (220)) that includes a set of POIs located within the search area and associated with the POI category (226), a route disruption metric associated with additional travel time may be determined for each POI within the set of POIs. The additional travel time may be determined by changing the established route to include the POI (e.g., as a new route, or as a side-trip to the given POI from an access point on the current route and then back to the access point on the current route).

At (708), the set of POIs may be ranked (e.g., by ranking engine (213)) based at least in part on the route disruption metrics to generate a ranked POI list (e.g., ranked POI search results (223)). The ranking may also account for search ranking and/or proximity of the respective POIs to the established route, as described with reference to FIG. 6.

At (710), a top-ranked POI from the POI list may be presented (e.g., at display 154). Subsequently, upon receiving a selection of the top-ranked POI, the established route may be updated to include the top-ranked POI.

Referring to FIGS. 1-5 and 8, the example method (800) may be performed by a map navigation tool (210) at a mobile computing device such as the device (100) of FIG. 1.

The example method (800) may start at (802), when an input specifying a destination point may be received. At this point, an input specifying a mode of transportation may also be received.

At (804), a travel route may be selected from a current location of the computing device to the destination point, where the selecting may be based at least in part on the mode of transportation.

At (806), a route offset (e.g., (225)) may be determined, where the route offset at least in part defines a search area. The search area may be located along part of the route, if the mode of transportation is driving, bicycling or walking. Or, the search area maybe located around a public transportation stop on the route (e.g., at the destination point, at an intermediate point), if the mode of transportation is public transport.

At (808), a search result (e.g., (220)) from a POI search within the search area may be received. The search result may include a set of POIs associated with a POI category (226).

At (810), the set of POIs in the search result may be ranked (e.g., by the ranking engine (213)) based on route disruption criteria calculated/determined for each of the POIs. The route disruption criteria for a given one of the POIs may measure additional travel, if the route is changed to include the given POI. One or more of the ranked set of POIs may be displayed (e.g., by the display (154)). In some instances, the ranking may also consider search ranking information (e.g., received for each POI together with the search results (220) from search server (262)), proximity to the current route information, and so forth.

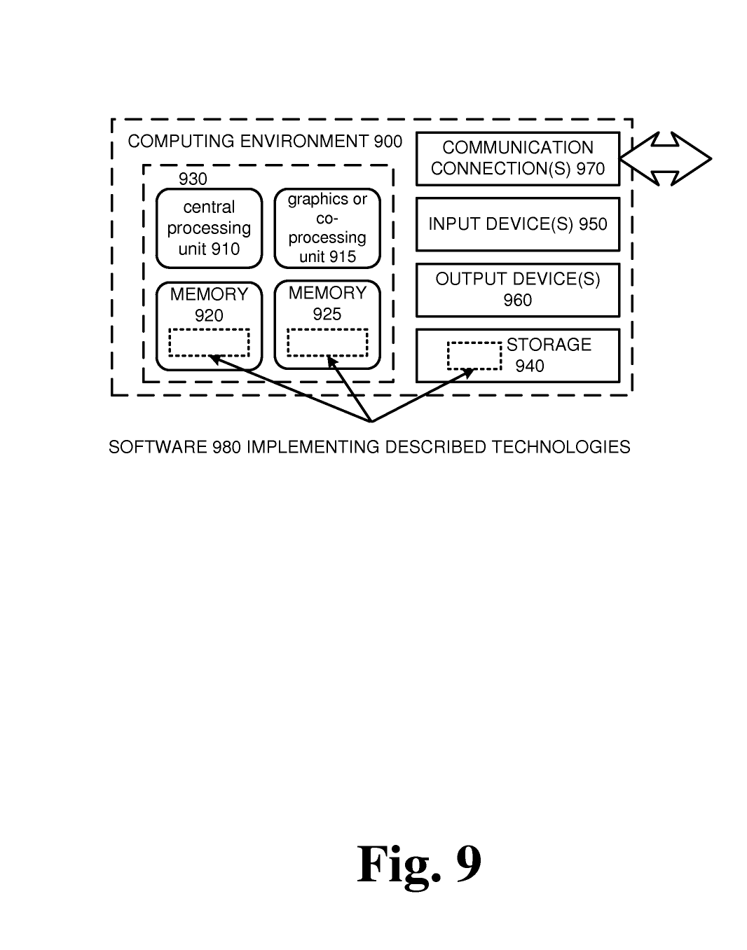

FIG. 9 is a diagram of an example computing system, in which one or more example embodiments of the disclosure can be implemented. The computing system (900) is not intended to suggest any limitation as to scope of use or functionality, as the innovations may be implemented in diverse general-purpose or special-purpose computing systems.

With reference to FIG. 9, the computing system (900) includes one or more processing units (910), (915) and memory (920), (925). In FIG. 9, this basic configuration (930) is included within a dashed line. The processing units (910), (915) execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit (910) as well as a graphics processing unit or co-processing unit (915). The tangible memory (920), (925) may be volatile memory (e.g., registers, cache, RAM), non-volatile memory (e.g., ROM, EEPROM, flash memory, etc.), or some combination of the two, accessible by the processing unit(s). The memory (920), (925) stores software (980) implementing one or more innovations described herein, in the form of computer-executable instructions suitable for execution by the processing unit(s).

A computing system may also have additional features. For example, the computing system (900) includes storage (940), one or more input devices (950), one or more output devices (960), and one or more communication connections (970). An interconnection mechanism (not shown) such as a bus, controller, or network interconnects the components of the computing system (900). Typically, operating system software (not shown) provides an operating environment for other software executing in the computing system (900), and coordinates activities of the components of the computing system (900).

The tangible storage (940) may be removable or non-removable, and includes magnetic disks, magnetic tapes or cassettes, CD-ROMs, DVDs, or any other medium which can be used to store information and which can be accessed within the computing system (900). The storage (940) stores instructions for the software (980) implementing one or more innovations described herein.

The input device(s) (950) may be a touch input device such as a keyboard, mouse, pen, or trackball, a voice input device, a scanning device, or another device that provides input to the computing system (900). The output device(s) (960) may be a display, printer, speaker, CD-writer, or another device that provides output from the computing system (900).

The communication connection(s) (970) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smartphones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 9, computer-readable storage media include memory (920) and (925), and storage (940). The term “computer-readable storage media” does not include signals and carrier waves. In addition, the term “computer-readable storage media” does not include communication connections (e.g., (970)).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. In a computing device, a method for providing search results, the method comprising:
receiving a search result from a point-of-interest (POI) search within a search area for a route, the search result comprising a set of POIs;
ranking the set of POIs in the search result based at least in part on route disruption criteria, the route disruption criteria for a given one of the POIs measuring additional travel if the route is changed to include the given POI; and
presenting one or more of the ranked set of POIs.

2. The method according to claim 1, further comprising:
receiving a selection of a POI category for the POI search, wherein the set of POIs comprises one or more POIs that fit the POI category.

3. The method according to claim 1, further comprising:
receiving a selection of a mode of transportation for the route.

4. The method according to claim 3, wherein the mode of transportation comprises one of driving, bicycling, traveling by public transportation, or walking.

5. The method according to claim 3, further comprising:
determining a route offset that at least in part defines the search area, the determining based at least in part on the mode of transportation.

6. The method according to claim 3, wherein the route is associated with a route travel time based at least in part on the mode of transportation.

7. The method according to claim 1, wherein the route is between a starting point and a destination point, the method further comprising:
determining a route offset, the route offset at least in part defining the search area for the route;
determining the search area based at least in part on the route offset and a portion of the route from a current location of the computing device to the destination point.

8. The method according to claim 1, further comprising:
receiving a selection of a POI from the ranked set of POIs.

9. The method according to claim 8, further comprising:
adjusting the route to include the selected POI.

10. The method according to claim 1, wherein the route disruption criteria is a route disruption time, the route disruption time for a given one of the POIs measuring additional travel time if the route is changed to include the given POI.

11. The method according to claim 1, further comprising:
receiving a search ranking for each of the set of POIs within the search result.

12. The method according to claim 11, wherein the ranking each of the set of POIs in the search result is also based at least in part on at least one of the search ranking and a proximity of the POI to a current location of the computing device or to an access point on the route that is nearest the POI.

13. A computing device that includes a processor and memory, the computing device being adapted to perform a method for providing search results, the method comprising:
receiving an input specifying a point-of-interest (POI) category;
determining a search area along an established route, the search area including an area around a portion of the established route located between a current location of the computing device and a destination point associated with the established route;
in response to receiving a search result comprising a set of POIs located within the search area and associated with the POI category:
determining for each POI within the set of POIs, a route disruption metric associated with additional travel time if the established route is changed to include the POI; and
ranking the set of POIs based at least in part on the route disruption metrics to generate a ranked POI list; and
presenting a top-ranked POI from the ranked POI list.

14. The computing device according to claim 13, wherein the method further comprises:
upon receiving a selection of the top-ranked POI, updating the established route to include the top-ranked POI.

15. The computing device according to claim 13, wherein the determining the search area is also based at least in part on a route offset, the route offset being selected based at least in part on a mode of transportation used for traveling along the established route.

16. The computing device according to claim 13, wherein the method further comprises:
receiving an input specifying the search area that includes the area around the portion of the established route located between the current location of the computing device and the destination point.

17. The computing device according to claim 16, wherein the input specifying the search area is received while providing navigation directions for driving between a starting point of the established route and the destination point.

18. The computing device according to claim 13, wherein the method further comprises:
accessing a user profile associated with the computing device; and
obtaining the input specifying the POI category from an email archive or an online calendar associated with the user profile.

19. The computing device according to claim 13, wherein the ranking the set of POIs is also based at least in part on distance from the respective POIs to the current location of the computing device or distance from the respective POIs to an access point on the route that is nearest the POI.

20. One or more computer-readable storage media storing computer-executable instructions for causing a computing device to perform a method for providing search results, the method comprising:
receiving input specifying a destination point;
selecting a travel route from a current location of the computing device to the destination point, the selecting being based at least in part on a mode of transportation;
determining a route offset, wherein the route offset at least in part defines a search area, the search area being located:
along part of the route, if the mode of transportation is driving, bicycling, or walking; or
around a public transportation stop on the route, if the mode of transportation is public transport;
receiving a search result from a point-of-interest (POI) search within the search area, the search result comprising a set of POIs associated with a POI category;
ranking the set of POIs in the search result based at least in part on route disruption criteria, the route disruption criteria for a given one of the POIs measuring additional travel if the route is changed to include the given POI; and
presenting one or more of the ranked set of POIs.
